(19) United States
(12) Patent Application Publication
(10) Pub. No.: US 2001/0056175 A1
(43) Pub. Date: Dec. 27, 2001

(54) Polysulfone films

(76) Inventors: Selvaraj Savariar, Duluth, GA (US); Geoffrey S. Underwood, Atlanta, GA (US)

Correspondence Address: BP America Inc., Docket Clerk, BP Legal, M.C. 2207A, 200 East Randolph Drive, Chicago, IL, 60601, US

(21) Appl. No.: 09/909,310

(22) Filed: Jul. 19, 2001

Related U.S. Application Data
(63) Continuation of application No. 09/340,909, filed on Jun. 28, 1999.

(51) Int. Cl. C08G 75/00

(52) U.S. Cl. 528/381

(57) ABSTRACT

A film comprising polysulfone wherein the polysulfone contains no more than about 1.4 weight percent sulfone cyclic dimer.

This application claims the benefit of U. S. Provisional Application No. 60/091,103 filed Jun. 29. 1998.

### FIELD OF THE INVENTION

This invention relates to novel films prepared from a poly(aryl ether sulfone) wherein the poly(aryl ether sulfone) contains low levels of sulfone cyclic dimer component. More particularly, this invention relates to optical films prepared from a poly(aryl ether sulfone) wherein the poly(aryl ether sulfone) comprises moieties from bisphenol A and also wherein the poly(aryl ether sulfone) contains no more than about 1.4 weight percent sulfone cyclic dimer component.

### BACKGROUND OF THE INVENTION

A number of poly(aryl ether sulfones) have been known for many years. They are linear polymers that possess a number of attractive features such as excellent high temperature resistance, good electrical properties, and toughness. One such important commercial poly(aryl ether sulfone) is available from Amoco Polymers, Inc., under the trademark of UDEL®. It corresponds to formula (1) and

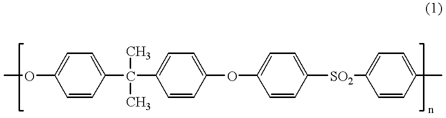

has a Tg of about 190° C., and is suitably made via the nucleophilic polycondensation of bisphenol A di-sodium salt with 4,4′-dichlorodiphenyl sulfone, as described in U.S. Pat. No. 4,108,837. Poly(aryl ether sulfones) which contain the moiety derived from bisphenol A are hereinafter referred to as polysulfones. Because of their excellent mechanical and other properties polysulfones can be used to manufacture a variety of films However, during the manufacture of polysulfones such as (1) a certain amount of sulfone cyclic dimer and cyclic oligomeric materials are also produced. The sulfone cyclic dimer has the structure (2).

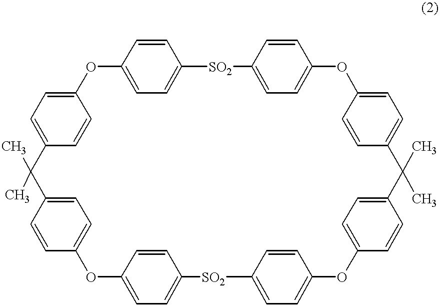

In one important method used for manufacturing films from a polysulfone polymer such as (1), a solution of the polymer in an appropriate low-boiling solvent is prepared, a predetermined amount of this solution is spread out in a form or mold and dried to remove the solvent, thereby leaving a film of a desired thickness. However, due to its physical properties, and cyclic dimer (2) is typically much less soluble in the solvent used to prepare the film and, either immediately after dissolving the polysulfone, or shortly thereafter, some of the cyclic dimer precipitates and produces a cloudy or hazy mixture. Hazy or cloudy films from such solutions are aesthetically poor and, if an optical film is desired, the haze or cloudiness renders the film unacceptable.

The art therefore needs film and particularly optical films which are made from a polysulfone wherein the level of cyclic dimer in the polysulfone is low. The present invention provides such films.

### SUMMARY OF THE INVENTION

This invention is a film comprising polysulfone wherein the polysulfone contains no more than about 1.4 weight percent sulfone cyclic dimer. This invention is a film, and preferably an optical film, wherein the film comprises a polysulfone and wherein the polysulfone used to make the film contains no more than about 1.4 weight percent, based on the weight of the polysulfone, of sulfone cyclic dimer having structure (2). The films of this invention have low levels of haze, particularly low haze due to the presence of sulfone cyclic dimer.

This invention is also a film comprising polysulfone, wherein the polysulfone used to make the film has no more than about 1.4 weight percent sulfone cyclic dimer and wherein the polysulfone, after its manufacture, has not been treated to remove sulfone cyclic dimer, for example, by a procedure comprising dissolving the polysulfone in a solvent, precipitating sulfone cyclic dimer and separating the precipitated cyclic dimer from the polysulfone.

### DETAILED DESCRIPTION OF THE INVENTION

This invention is a film, preferably an optical film, which is made from a polysulfone thermoplastic resin, and wherein the polysulfone contains no more than about 1.4 weight percent, more preferably no more than about 1.3 weight percent, and most preferably no more than about 1.2 weight percent sulfone cyclic dimer.

The polysulfones useful for making the films of this invention comprise the repeating unit

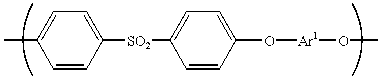

wherein preferably in at least about 50 and more preferably in at least about 75 mole percent of the repeat units the divalent Ar¹ groups is

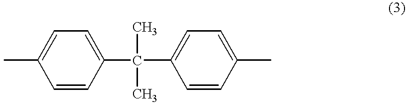

(i.e., derived from Bisphenol A or the like). The divalent Ar₁ group in the other repeat units, if any. is preferably at least one member selected from p-phenylene, 4,4′-diphenyl sulfone and moieties from other bisphenols. Polysulfones are available from Amoco Polymers Inc. under the trade name Udel The Udel polysulfones are preferred polysulfones for making the films of this invention. By “bisphenol A moiety” or “moiety derived from bisphenol A” we mean the portion or residue which can be derived from bisphenol A and which has the structure (3) above.

The term “film” as used herein generally means sheet-like materials. typically clear, preferably. but not necessarily. flat or planar and preferably where the thickness of the film is about 10 μM to about 400 μM. more preferably about 10 μM to about 200 μM (μM means micrometers). The film can be used for a variety of applications including packaging, electronic components (such as an insulating layer), protective layers or covering. etc. The term optical film as used herein means any film that is used to provide for the transmission of light including, for example, low birefringent optical films having a retardation of 100 nm or less which are useful, for example, as a protective film for a polarizing sheet. and birefringent optical films such as those having a retardation of ¼λ (130 to 150 nm. λ is a wave length of incident light) which are useful for anti-glare materials, and typically used in various anti-glare devices such as visual display terminal (VDT) filters.

The “retardation” value R, referred to above. is the product of the birefringence of the film and the thickness of the film which is expressed by the following equation.

R=d×|n₁−n₂|=Δn×d

(wherein d represents the thickness of film. n₁ represents the refractive index in the direction of optic axis or the direction at right angles therewith. n₂ represents the refractive index in the direction perpendicular to the direction of n₁. and the refractive index is a value relative to the sodium D line). The films of the present invention. and particularly the optical films, can be continuously prepared from the polysulfone thermoplastic resin by solvent casting, melt extrusion, calendering, and the like, with solvent casting being preferred. Films prepared by solvent casting are most preferred because the resulting films generally have excellent thickness uniformity and tend to have fewer defects such as gels or foreign particles.

While carrying out solvent casting it is important to properly maintain the concentration of the polysulfone or polysulfone-containing polymer in the casting solution. A suitable concentration of the polysulfone or polysulfone-containing polymer is usually about 15 to about 35% by weight based on the total weight of the solution.

The solvent used for solvent casting is any solvent that can dissolve the polysulfone and which is. preferably, of sufficient volatility so it can be easily evaporated from the solution to form the film. Suitable solvents included. for example, methylene chloride, chlorobenzene. 1.3 dioxolane, and tetrahydrofuran.

The film as produced sometimes suffer from defects such as die lines or undergo slight orientation depending on the film formation conditions. Such slight orientation can be effectively reduced by subjecting the film to a heat treatment. When a heat treatment of the film is carried out at temperatures above the heat distortion temperature of the film, the birefringence of the film becomes essentially zero to provide an optical film exhibiting no birefringence. This film is suitable for uses requiring zero birefringence, such as a protective film for a polarizing sheet, a protective film for a laser card. etc. Alternatively the zero birefringence film can be subjected to uniaxial or biaxial stretching so as to provide for desired birefringence.

Uniaxial stretching of the film can be performed by known techniques including transverse uniaxial stretching by tentering, longitudinal uniaxial stretching utilizing a difference in peripheral speed of rolls. and compression stretching between rolls. In particular, transverse uniaxial stretching by tentering is preferred for reducing any optical color unevenness of the resulting film.

To achieve uniform stretching in transverse uniaxial stretching, it is important to appropriately select a proper stretching temperature. The stretching temperature should be above the temperature at which a yield point of stress-strain curve of tensile test apparently disappears. If it is in the temperature range where a yield point appears in the stress-strain curve or at a lesser temperature, the stretching becomes non-uniform causing unevenness in the thickness of the film, and the resulting stretched film has a large fluctuation and a large rate of change in retardation.

Biaxial stretching can be carried out by successive stretching comprising first uniaxial stretching by any of the above-described techniques followed by second stretching in the direction perpendicular to the first stretching, simultaneous biaxial stretching comprising longitudinal stretching simultaneously with transverse stretching and the like. The biaxial stretching technique is appropriately selected according to desired physical properties.

The stretch ratio is not particularly limited. It is usually from about 1.2 to about 6.0 and preferably from about 1.2 to about 4.0. though more or less varying depending on the result desired.

A heat treatment after stretching is useful for improvement of dimensional stability and uniformity of retardation of the resulting stretched film. The heat treatment temperature is preferably selected in the range of from about the heat distortion temperature up to the stretching temperature.

The retardation (R) value of the optical film can be appropriately selected depending on the end use. For example. for use as a color compensator of super twisted nematic (STN) mode liquid crystal displays. a suitable R value ranges from about 200 to about 1000 nm. For use as an optical film for compensating for color unevenness of a liquid crystal cell and improving image quality. a suitable R value ranges from about 0 to about 200 nm. For use as an optical film having biaxial orientation for improving view angle characteristics. etc. a suitable R value is about 500 nm or less. For use as a protective film for polarizing sheets. the film suitably has an R value of not more than about 100 nm and preferably has no orientation. Further, a suitable R value for use as an optical filter, etc. is selected from about 0 to about 1200 nm according to the purpose.

Descriptions and methods for preparing optical films are provided in U.S. Pat. No. 5,244,713 which is hereby incorporated by reference.

Polysulfones can be prepared by methods known in the art. For example. they can be made by what is known as the carbonate method or by the alkali metal hydroxide method.

In the carbonate method. the polysulfones are prepared by contacting substantially equimolar amounts of bisphenol A. optionally with one or more other bishydroxy aromatic compounds. and dihalodiarylsulfones, e.g., 4,4′-dichlorodiphenyl sulfone or 4,4′-difluorodiphenyl sulfone, with from about 0.5 to about 1.0 mole of an alkali metal carbonate per mole of hydroxyl group in a solvent mixture comprising a solvent which forms an azeotrope with water in order to maintain the reaction medium at substantially anhydrous conditions during the polymerization. The temperature of the reaction mixture is kept at about 170° C. to about 250° C., preferably from about 210° C. to about 235° C. for about one to 15 hours.

In a modification which is particularly suitable for making copolymers from bisphenol A and one or more additional dihydroxy compounds, the reactants other than the additional dihydroxy compounds are charged and heated at from about 120° C. to about 189° C. for about one to about 5 hours. the additional dihydroxy compounds are added, the temperature is raised and the mixture is heated at from about 200° C. to about 250° C., preferably from about 210° C. to about 240° C., for about one to 10 hours.

The reaction is carried out in an inert atmosphere, e.g., nitrogen, at atmospheric pressure, although higher or lower pressures may also be used.

The polysulfone is then recovered by conventional techniques such as coagulation. solvent evaporation. and the like.

The solvent mixture comprises a solvent which forms an azeotrope with water and a polar aprotic solvent. The solvent which forms an azeotrope with water includes aromatic hydrocarbons such as benzene, toluene, xylene, ethylbenzene, chlorobenzene, and the like.

The polar aprotic solvents employed are those generally known in the art for the manufacture of polyarylether sulfones and include sulfur containing solvents such as those of the formula:

R₁—S(O)_{b}—R₁

in which each R₁ represents a monovalent lower hydrocarbon group free of aliphatic unsaturation. which preferably contains less than about 8 carbon atoms or when connected together represents a divalent alkylene group with b being an integer from 1 to 2 inclusive. Thus. in all of these solvents. all oxygens and two carbon atoms are bonded to the sulfur atom. Contemplated for use in making poly(aryl ether sulfones) are such solvents as those having the formula:

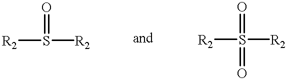

where the R₂ groups are independently lower alkyl, such as methyl, ethyl, propyl. butyl. and like groups, and aryl groups such as phenyl and alkylphenyl groups such as the tolyl group, as well as those where the R₂ groups are interconnected as in a divalent alkylene bridge such as

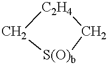

in teirahydrothiophene oxides and dioxides. Specifically, these solvents include dimethylsulfoxide, dimethylsulfone, diphenylsulfone, diethylsulfoxide, diethylsulfone, diisopropylsulfone. tetrahydrothiophene-1,1-dioxide (commonly called tetramethylene sulfone or sulfolane) and tetrahydrothiophene-1-monoxide.

Additionally, nitrogen containing solvents may be used. These include dimethylacetamide, dimethylformamide and N-methyl-pyrrolidone.

The azeotrope forming solvent and polar aprotic solvent are used typically in a weight ratio of from about 1:10 to about 1:1, preferably from about 1:5 to about 1:3.

In the reaction, the hydroxy containing compound, e.g., bisphenol A, is slowly converted, in situ, to the alkali salt thereof by reacting with the alkali metal carbonate. The alkali metal carbonate is preferably potassium carbonate. As indicated before. mixtures of carbonates such as potassium and sodium carbonate may also be used.

Water is continuously removed from the reaction mass as an azeotrope with the azeotrope forming solvent so that substantially anhydrous conditions are maintained during the polymerization.

It is essential that the reaction medium be maintained substantially anhydrous during the polycondensation. While amounts of water up to about one percent can be tolerated. and are somewhat beneficial when employed with fluorinated dihalobenzenoid compounds. amounts of water substantially greater than this are desirably avoided as the reaction of water with the halo compound leads to formation of phenolic species and only low molecular weight products are obtained. Consequently, in order to secure the high polymers, the system should be substantially anhydrous. and preferably contain less than 0.5 percent by weight water during the reaction.

Preferably, after the desired molecular weight has been attained, the polymer is treated with an activated aromatic halide or an aliphatic halide such as methyl chloride or benzyl chloride, and the like. Such treatment of the polymer converts the terminal hydroxyl groups into ether groups which stabilize the polymer. The polymer so treated has good melt and oxidative stability.

While the carbonate method for preparing the polymers used in this invention is simple and convenient, in some cases products of higher molecular weight can be made by the alkali metal hydroxide method. In the alkali metal hydroxide method, described by Johnson et al., U.S. Pat. Nos. 4.108.837 and 4.175,175, a double alkali metal salt of a dihydric phenol is contacted with a dihalobenzenoid compound in the presence of a sulfur containing solvents herein above defined under substantially anhydrous conditions.

Additionally. polysulfones can be prepared by other methods known in the art, in which at least one dihydric phenol comprising bisphenol A and at least one dihalobenzenoid compound are heated, for example. with a mixture of sodium carbonate or bicarbonate and a second alkali metal carbonate or bicarbonate having a higher atomic number than that of sodium. as described in U.S. Pat. No. 4,176,222.

The molecular weight of the polysulfones utilized for manufacturing the films the instant invention is indicated by reduced viscosity data in an appropriate solvent such as methylene chloride chloroform, N-methylpyrolidone, and the like. The reduced viscosities of the polysulfones, as measured at concentrations of 0.2 g per 100 ml. at 25° C., are suitably at least 0.3 dl/g, preferably at least 0.4 dl/g and, typically, not exceeding about 1.5 dl/g.

The polysulfones may also include additives such as thermal stabilizers, ultraviolet light stabilizers, plasticizers, and the like.

During the manufacture of polysulfone, including the methods described hereinabove, a certain amount of cyclic oligomeric materials are produced as side products. One such cyclic oligomer is the sulfone cyclic dimer (2). In solutions of polysulfone, the majority of the dimer of structure (2) is present in soluble form; however. a small amount is present in insoluble crystalline form. The amount present in crystalline form increases if the solution is kept for a few days due to continued crystallization of the cyclic dimer. The crystalline sulfone cyclic dimer causes undesirable levels of haze in films, and particularly optical films.

The films. and more preferably, the optical films of this invention, are made with a polysulfone having a low level of cyclic dimer. The polysulfones used to make the film of this invention typically contain no more than about 1.4 weight percent sulfone cyclic dimer, more preferably no more than about 1.3 weight percent cyclic dimer. and most preferably no more than about 1.2 weight percent cyclic dimer based on the weight of the polysulfone. Films, and particularly optical films, of this invention comprising polysulfone having about 0.1 to about 1.0, more preferably about 0.1 to about 0.7 weight percent sulfone cyclic dimer are advantageous. The films of this invention, and particularly the optical films have a low level of haze as measured by ASTM D-1003-35. The haze is preferably no more than about 3.0. more preferably no more than about 2.0 and most preferably no more than about 1.3 well measured on a film having a thickness of 2 mil.

A number of methods can be used to prepare polysulfone with low cyclic dimer. In one method. the “solution method” a predetermined amount of polysulfone is dissolved in a suitable solvent and is set aside to permit the precipitation of cyclic dimer. After a sufficient period of time the cyclic dimer is separated from the solution by filtration, settling, centrifugation, or any other method that can be used to separate solids from liquids. Prior to filtration or other separation, additional solvent is added to assist with the separation. The liquid solution obtained contains polysulfone having a reduced level of cyclic dimer. The solvent can be removed, for example, by evaporation, distillation or combination thereof, to prepare a neat polymer with low levels of cyclic dimer. Suitable solvents for this process include, for example, methylene chloride, chlorobenzene, 1,3-dioxolane, or any other solvent that dissolves the polysulfone and also allows for the precipitation of the sulfone cyclic dimer. The concentration of polysulfone in solvent can be about 10 to about 50 weight percent, more preferably about 20 to about 30 weight percent. The amount of time the solution stands prior to adequate precipitation will vary depending on the temperature, concentration of polymer and solvent selected. Generally. using the concentration and solvents mentioned above, 1-10 days is sufficient.

Another method for preparing polysulfone with low cyclic dimer is the coagulation or anti-solvent method. In this method polysulfone is dissolved in a suitable solvent such as, for example, dimethyl sulfoxide. chlorobenzene, or mixtures thereof, to form a solution of the polysulfone. This solution is mixed with an anti-solvent, i.e. a solvent in which the polysulfone is insoluble, for example, methanol, ethanol. isopropanol, water. mixtures of methanol and chlorobenzene, and the like. Preferably, the anti-solvent is selected so that it is miscible with the dissolving solvent. Upon mixing with the anti-solvent, polysulfone containing the reduced level of cyclic dimer rapidly comes out of solution, i.e. coagulates, and can be removed from the mixture by filtration, centrifugation, settling and the like. The concentration of polysulfone in the solvent can be about 1 to about 20 weight percent, preferable about 2 to about 10 weight percent. The ratio of solvent to anti-solvent is suitably about 1:2 to about 1:50, preferably about 1:5 to about 1:30. Both the solution method and the coagulation method are methods for preparing low sulfone cyclic dimer polysulfone by removing sulfone cyclic dimer from polysulfone after the polysulfone is formed in the polymerization process.

Another method for preparing polysulfone with low levels of cyclic dimer is not based on a removal of sulfone cyclic dimer from polysulfone after the polymerization as described, for example, in the previous two procedures. Rather. in this preferred method for preparing polysulfones used to prepare the films of this invention, polysulfone is prepared firsthand with low levels of cyclic dimer. For example. the polymerization reaction can be used to produce polysulfone with low levels of polysulfone cyclic dimer. As described above, polysulfone is typically prepared by reacting a dihalodiarylsulfone, e.g., 4.4′-dichlorodiphenyl sulfone with dihydroxy aromatic compounds comprising bisphenol A under substantially anhydrous condition in the presence of a base and a mixture of polar aprotic solvent and a solvent which forms an azeotrope with water. By appropriately adjusting the concentration of bisphenol A (and other bisphenols if used) and 4.4′-dihalodiarylsulfone in the solvent mixture, polysulfone having a substantially reduced amount of sulfone cyclic dimer can be prepared. Thus. when the concentration of 4,4′-dihalodiaryl sulfone and bisphenol A in the polymerizationreaction solution mixture is such that the resulting polysulfone is present in the polymerization reaction mixture at the end of the polymerization reaction in at least about 30 weight percent, more preferably at least about 40 weight percent and most preferably at least about 50 weight percent based on the total weight of the final polymerization solution (excluding byproduct salts such as sodium chloride) polysulfone containing low levels of sulfone cyclic dimer can be prepared. For example. polysulfone having no more than about 1.4 weight percent sulfone cyclic dimer, more preferably no more than about 1.3 weight percent sulfone cyclic dimer and most preferably no more than about 1.2 weight percent sulfone cyclic dimer can be prepared by this method. The films made from polysulfone wherein the polysulfone was not treated with a solvent to remove cyclic dimer are the preferred films of this invention. Preferably. such films are made from polysulfone manufactured using a polymerization process, such as that described hereinabove, by adjusting the concentration of reactants in the polymerization reaction solution mixture to produce low levels of sulfone cyclic dimer. e.g. no more than about 1.4 weight percent . more preferably no more than about 1.3 weight percent. most preferably. no more than about 1.2. weight percent based on the weight of the polysulfone.

The following examples provide specific illustrations of the present invention and are not to be construed in any way as a limitation on its scope or generality.

### EXAMPLES

The polysulfone used for the following examples is Udel P-1700, a commercial polysulfone supplied by Amoco Polymers, Inc. It is a polymer having the following repeat unit.

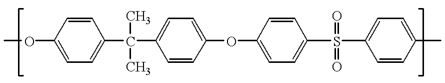

It has a reduced viscosity of about 0.50 g/dl in chloroform at 25° C. at a concentration of 0.2 g/dl. and a number-average molecular weight by gel permeation chromatography of about 15,000 using tetrahydrofuran (THF) as solvent and a polystyrene molecular weight calibration standard.

This polysulfone has a sulfone cyclic dimer level of 1.5% by weight. The amounts of sulfone cyclic dimer in the polysulfones described herein were measured using gel permeation chromatography (GPC). The GPC procedure is as follows:

Polysulfone in the form of a pellet. a precipitated powder sample, or a polysulfone reaction solution was dissolved in methylene chloride to form a solution of about 0.4% polysulfone by weight. The solution was analyzed by two 5 μm mixed-D size Size Exclusion Chromatography columns from Polymer Laboratories. GPC analyses were completed using 10 μL of the polymer solution as injection volume and with methylene chloride as mobile phase with a flow rate of 1.5 ml/min. The detection was accomplished with UV light (254 nm). The last peak at the end of the tail of the polysulfone chromatogram and before that of any residual solvents like dimethylsulfoxide and chlorobenzene that may be present was determined to be sulfone cyclic dimer. The areas of sulfone cyclic dimer peak and the whole area of polysulfone peak were measured and the weight percent cyclic dimer was calculated from these areas. A standard polysulfone sample containing 1.5 weight percent cyclic dimer was used to calibrate the GPC procedure.

### Example 1

Table 1 shows the results of the “solvent method” for reducing the level of sulfone cyclic dimer in polysulfone. In this example, solutions of a polysulfone containing 1.50 weight percent cyclic dimer were prepared in the listed solvents and listed concentrations by dissolving pellets of the polysulfone using agitation to accelerate dissolution. After dissolution, the solutions were stored for the number of days listed during which time they became cloudy.

The cloudy solutions were diluted with additional solvent to achieve 10% (by weight) solutions of polymer in solvent. After such dilution, each solution was immediately filtered through a 5.0 micron PTFE membrane filter. The solids filtered from the experiment using methylene chloride were analyzed and found to be 85 weight percent polysulfone cyclic dimer, i.e. (2). The filtrates were analyzed for polysulfone cyclic dimer content and the results of the analysis are also shown in Table 1.

These data show that the solution method can be used for preparing polysulfone with low sulfone cyclic dimer.

### Example 2

Table 2 shows the results of the “coagulation method” for reducing the level of sulfone cyclic dimer in polysulfone. In this example. solutions of polysulfone containing 1.50 weight percent sulfone cyclic dimer were prepared in the listed solvents (DMSO is dimethyl sulfoxide, MCB is chlorobenzene) and listed concentrations by dissolving pellets of the polysulfone using agitation to accelerate dissolution. After dissolution the solutions were slowly added to non-solvent. or anti-solvent, as listed. The addition was accomplished in a blender using rapid stirring. The addition to the non-solvent caused the rapid precipitation or coagulation of the polysulfone, which was collected by filtration. weighed and analyzed for content of sulfone cyclic dimer. Recovery of polysulfone was greater than 97%. The amount of cyclic dimer present in the recovered polysulfone is shown in Table 2.

These data demonstrate that the coagulation method is useful for preparing polysulfone with low sulfone cyclic dimer levels.

TABLE 1

| Concentration of | | Days | wt % Cyclic Dimer |
|---|---|---|---|
| Polysulfone in | | Solution | in Solution After |
| Solvent (wt %) | Solvent | Aged | Filtration* |
| 30 | chlorobenzene | 5 | 0.70 |
| 40 | chlorobenzene | 10 | 0.71 |
| 30 | methylene chloride | 5 | 0.65 |
| 40 | methylene chloride | 10 | 1.03 |
| 30 | 1,3-dioxolane | 4 | 0.61 |
| 30 | 1:9.methanol/ | 4 | 1.19 |
| | chlorobenzene | | |

*Based on weight of polysulfone

TABLE 2

| Concentration | | Non-solvent | | Wt % Cyclic |
|---|---|---|---|---|
| of Polysulfone | | | Ratio of | Dimer in |
| in Solvent | | | Solvent | Recovered |
| (wt %) | Solvent | | Non-solvent | Polysulfone |
| 18.0 | DMSO/ | methanol | 1:5 | 1.50 |
| | MCB^{a} | | | |
| 7.4 | DMSO/ | methanol | 1:5 | 1.11 |
| | MCB^{a} | | | |
| 2.0 | DMSO/ | methanol | 1:5 | 0.23 |
| | MCB^{a} | | | |
| 18.0 | DMSO/ | methanol | 1:25 | 1.23 |
| | MCB^{a} | | | |
| 7.4 | DMSO/ | methanol | 1:25 | 0.88 |
| | MCB^{a} | | | |
| 2.0 | DMSO/ | methanol | 1:25 | 0.28 |
| | MCB^{a} | | | |
| 15 | MCB | methanol | 1:5 | 1.50 |
| 15 | MCB | methanol | 1:11 | 1.44 |
| 15 | MCB | methanol | 1:4 | 1.50 |
| 15 | MCB | methanol/MCB | 1:5 | 0.92 |
| | | (75/25)^{b} | | |
| 10 | MCB | methanol/MCB | 1:5 | 0.63 |
| | | (75/25)^{b} | | |
| 10 | MCB | methanol/MCB | 1:5 | 0.62 |
| | | (75/25)^{b} | | |
| 10 | MCB | methanol/MCB | 1:5 | 0.54 |
| | | (75/2S)^{b} | | |
| 10 | MCB | methanol | 1:11 | 1.29 |

^{a}weight ratio DMSO to MCB of 1:3 to 1:50
^{b}weight ratio

### Example 3

To a 500 ml 4-neck round bottom reactor flask, equipped with overhead stirrer. thermocouple. nitrogen inlet and a Dean Stark trap filled with chlorobenzene topped by a water cooled condenser. was charged 51.36 g of bisphenol A (.225 moles), 144 g chlorobenzene (MCB) and 105 grams of dimethyl sulfoxide (DMSO) and purged with nitrogen for ½ hour. A 35.78 g solution of 50.11% sodium hydroxide was then added to the flask. The mixture was refluxed for 90 minutes with removal of water from the trap along with return of chlorobenzene to the flask. After a 90 minute dehydration period, the trap was drained of MCB and water and the MCB was continuously removed from the reactor in order to get to 165° C. At 165° C. a solution containing 64.62 g dichlorodiphenyl sulfone (0.225 moles) and 34.8 g chlorobenzene was added over two minute period. The sulfone monomer solution was added and the evaporated MCB was removed from the reactor as quickly as possible The reaction was continued until a reduced viscosity of 0.50 dl/g (chloroform solvent, 0.2 g polymer in 100 ml at 25° C.) was reached. At this point almost all of the MCB was removed and the concentration of polysulfone in the remaining mixture was about 50% by weight based on the total weight of mixture, except for the salts. The mixture was diluted with 200 ml of chlorobenzene, and cooled to 120° C. At 120° C. methyl chloride was bubbled into the reaction for 30 minutes. After 30 minutes. a 1.04 g solution of 25% NaOH was added and the addition of methyl chloride was continued for another 30 minutes. The reaction was diluted further with about 100 ml MCB. the heat source removed and the reaction allowed to cool to about 90° C. At 90° C., a 10.0 ml solution of oxalic acid in DMSO (0.07 g oxalic acid dihydrate/1 ml DMSO) was added and the reaction mixed for 5 minutes.

The polymer solution was pressure filtered through a 1.5 micron (nominal) glass fiber filter membrane. The polymer was recovered by slowly adding the solution into a solution of a methanol and water (70/30 w/w). which was rapidly stirred in a blender. The ratio of the polymer solution to methanol/water solution was 1:10 w/w. The polymer was recovered by filtration and was washed thoroughly in the blender with fresh methanol/water solution of same ratio. The wet polymer was dried in a vacuum oven at 150° C. for 20 hrs. The reduced viscosity as measured in chloroform (0.2 g polymer in 100 ml at 25° C.) was greater 0.50 dl/g. The sulfone cyclic dimer was measured to be 1.15 wt % by the GPC method described above.

### Example 4

Polysulfone pellets (60 g) were added to methylene chloride (140 g) at room temperature. The resulting slurry was agitated overnight with overhead mechanical stirring to produce a 30 wt % solution. The resulting solution was poured into a doctor blade (thickness 8 mil) which was placed on a level glass plate and strips of 8 mil thick polymer solutions were obtained by slowly drawing the doctor blade. Solvent was allowed to evaporate at room temperature inside a fume-hood by setting aside the wet solvent containing strips without any disturbance. After drying the films at 50° C. for 3 hours in an oven to condition the films, thickness was measured to be about 2 mil by a micrometer. Multiple film samples were made from polysulfone samples containing 1.5 and 1.1 % by weight sulfone cyclic dimer levels.

Strips of films measuring 2.5″×4″ were cut out from the films made by the above method. Slides were made out of these film strips by pasting hard paper on all four sides of the film The resulting slides were used as samples for haze measurements.

Haze was measured by a haze meter according to the ASTM D1003-35 test method. The results are shown in Table 3.

TABLE 3

| | % Sulfone Cyclic | |
|---|---|---|
| | Dimer in the | |
| | Polysulfone Sample | |
| | Used to Make | |
| Film | the Film | Haze % |
| 1 | 1.5 | 3.6 |
| 2 | 1.5 | 3.5 |
| 3 | 1.5 | 3.5 |
| 4 | 1.1 | 0.8 |
| 5 | 1.1 | 0.8 |
| 6 | 1.1 | 1.1 |

The results in Table 3 show that the films made from polysulfone resin containing 11 % cyclic dimer have much less haze compared to the films made with polysulfone resin containing 1.5% by weight cyclic dimer.

1. A film comprising polysulfone wherein the polysulfone contains no more than about 1.4 weight percent sulfone cyclic dimer.

2. The film of claim 1 which is an optical film.

3. The film of claim 1 wherein the polysulfone is prepared by a polymerization procedure which produces a polysulfone containing no more than about 1.4 weight percent sulfone cyclic dimer.

4. The film of claim 1 prepared by solvent casting.

5. The film of claim 2 having a retardation of about 1 to about 1000 nm.
